(19) United States
(12) Patent Application Publication
(10) Pub. No.: US 2010/0010997 A1
(43) Pub. Date: Jan. 14, 2010

(54) METHOD AND SYSTEM FOR RESCORING A PLAYLIST

(75) Inventors: Christopher M. Amidon, Apex, NC (US); Sean T. Purdy, Durham, NC (US)

Correspondence Address: WITHROW & TERRANOVA CT, 100 REGENCY FOREST DRIVE , SUITE 160, CARY, NC, 27518, US

(73) Assignee: Abo Enterprise, LLC, Wilmington, DE (US)

(21) Appl. No.: 12/171,523

(22) Filed: Jul. 11, 2008

(51) Int. Cl. G06F 7/00; G06F 17/30

(52) U.S. Cl. 707/7; 707/E17.002

(57) ABSTRACT

A method and system are provided for rescoring media items in a playlist in response to associated user events. In one embodiment, media items in a playlist are scored based on user preferences of an associated user, and the playlist is sorted based on the scores of the media items. At some point during playback of the media items in the playlist, a user event is detected. In response to detecting the user event, a reason for the user event is determined. Then, matching media items in the playlist are rescored, and the playlist is resorted. The matching media items are media items that match, at least to some degree, the media item with respect to which the user event occurred in light of the reason for the user event.

### FIELD OF THE INVENTION

The present invention relates to scoring media items in a playlist and more particularly relates to rescoring media items in a playlist in response to user events.

### BACKGROUND OF THE INVENTION

Scoring algorithms are often used to score songs in a playlist and to sort the playlist. Typically, the scoring algorithms score the songs in the playlist based on a static user profile or user preferences of the associated user. However, these static user profiles result in scores for the songs that do not always reflect the current listening preferences of the user. For example, the preferences of the user may vary based on various contextual factors such as the user's current location, the user's mood, friends that are proximate to the user, or the like. As such, there is a need for a system and method for rescoring media items, such as songs, in a playlist in a manner that more accurately reflects the current preferences of the user.

### SUMMARY OF THE INVENTION

The present invention relates to rescoring media items in a playlist in response to associated user events. In one embodiment, media items in a playlist are scored based on user preferences of an associated user, and the playlist is sorted based on the scores of the media items. At some point during playback of the media items in the playlist, a user event is detected. The user event may be, for example, skipping a media item in the playlist, replaying a media item in the playlist, applying a rating to a media item in the playlist, manually rescoring a media item in the playlist, recommending a media item in the playlist to another user, or the like. In response to detecting the user event, a reason for the user event is determined. The reason for the user event may be determined by prompting the associated user for the reason for the user event. Then, matching media items in the playlist are rescored, and the playlist is resorted. The matching media items are media items that match, at least to some degree, the media item with respect to which the user event occurred in light of the reason for the user event. In one embodiment, the matching media items are temporarily scored for a current playback session of the associated user. In another embodiment, the matching media items are permanently rescored.

In another embodiment, media items in a playlist are scored based on user preferences of an associated user, and the playlist is sorted based on the scores of the media items. In response to detecting a user event, media items matching, at least to some degree, the media item with respect to which the user event occurred are identified and temporarily rescored. For example, the matching media items may be rescored for the current playback session. The scores of the matching media item may return to their original scores upon the initiation of a subsequent playback session by the associated user.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a process for rescoring media items in a playlist according to one embodiment of the present invention;

FIGS. 2 through 4 graphically illustrate a playlist being rescored using to the process of FIG. 1 according to one embodiment of the present invention;

FIG. 5 is a functional block diagram of a user device including a playlist control function for rescoring media items in a playlist according to one embodiment of the present invention;

FIG. 6 is a block diagram of an exemplary implementation of the user device of FIG. 5;

FIG. 7 illustrates a system including a central server hosting a playlist control function for rescoring media items in a playlist according to one embodiment of the present invention; and

FIG. 8 is a block diagram of an exemplary implementation of the central server of FIG. 7.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

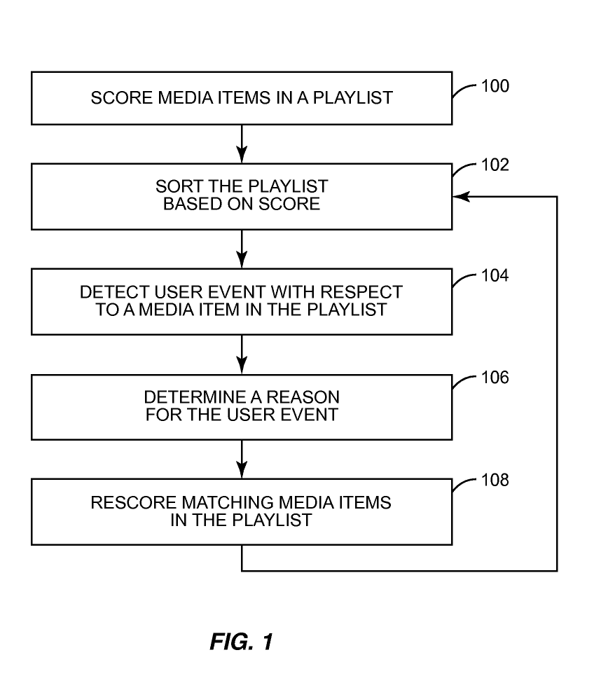

FIG. 1 illustrates a process for rescoring media items in a playlist in response to user events according to one embodiment of the present invention. As used herein, a media item may be a song or other audio content item, a video such as a video clip, movie, or television program, or the like. While referred to herein as a playlist including a number of media items, it will be appreciated by one or ordinary skill in art that, in implementation, the playlist may be formed of references or identifiers of the media items rather than the media items.

First, media items in a playlist are scored to provide initial or baseline scores for the media items (step 100). The media items in the playlist may be manually selected by an associated user or automatically selected based on one or more criteria provided by the associated user such as, for example, a seed song. Note that the media items may initially be scored before or after the playlist is created. In one embodiment, the media items are scored as a function of one or more scoring criteria and weights assigned to the scoring criteria. The scoring criteria may be user-defined scoring criteria or system-defined scoring criteria. The weights assigned to the scoring criteria may be manually set by the associated user; programmatically or automatically set by a corresponding playlist control function based on, for example, an analysis of media items in the associated user's media collection; a play history of the associated user; or the like.

While the manner in which the media items in the playlist are initially scored is not particularly relevant to the present invention, in one exemplary embodiment, the media items may be scored based on user preferences in the manner described in U.S. Patent Application Publication No. 2008/0016205, entitled P2P NETWORK FOR PROVIDING REAL TIME MEDIA RECOMMENDATIONS, which was filed on Jul. 11, 2006 and is hereby incorporated by reference in its entirety. In general, the user preferences of the user define a number of scoring categories. Using songs as an example, the scoring categories for scoring songs may include artist, genre, decade of release, source (e.g., local storage, remote server, device of another user, etc.), or the like. Then, for each scoring category, a number of attributes are defined. For example, for the genre category, the attributes may include Rock, Country, Metal, Classical, Jazz, or the like. Likewise, for the decade of release category, the attributes may include 1950s, 1960s, 1970s, 1980s, 1990s, and 2000s. Weights are then assigned to each scoring category and each of the defined attributes for each scoring category. The weights may be manually set by the user or automatically set based on an analysis of the media collection of the user and/or a play history of the user. Further, some of the weights may be manually set by the user while other weights may be automatically set. Then, based on the weights, each song in the playlist may be scored based on the following equation:

$$Score = {\sum }_{i = 1}^{N} ( \frac{{W}_{CAT , i}}{{W}_{CAT\_TOTAL}} \cdot \frac{{W}_{ATT , i}}{{W}_{ATT\_MAX}} ) \cdot 100 ,$$

where N is the number of scoring categories, W_{CAT} is the weight assigned to a scoring category (e.g., artist category, genre category, decade of release category, source category, or the like), W_{CAT}_{_{—}}_{TOTAL} is a sum of the weights assigned to all of the scoring categories, W_{ATT} is a weight assigned to an attribute matching the song being scored from the corresponding scoring category, and W_{ATT}_{_{—}}_{MAX} is a maximum weight that can be assigned to an attribute. Note that in some implementations the score may also be determined based on a no-repeat-factor. The no-repeat-factor may be desirable where the playlist is periodically re-sorted based on score, and the top media item in the playlist is selected as the next media item to be played. The no-repeat-factor may be utilized to move a media item down the playlist after it is played such that the media item having the top, or most desirable, score is not continuously repeated.

As an example, assume that the following category weights have been assigned:

| | |
|---|---|
| Source Category | 1 |
| Genre Category | 7 |
| Decade Category | 7 |
| Artist Category | 5 |

Further assume that the attributes for the categories have been assigned weights as follows:

| Source | | Genre | | Decade | | Artist | |
|---|---|---|---|---|---|---|---|
| Local | 5 | Alternative | 8 | 1950s | 2 | Elvis | 8 |
| Remote | 5 | Classic Rock | 5 | 1960s | 4 | Alabama | 7 |
| User A | 5 | Arena Rock | 5 | 1970s | 7 | Jimmy Buffett | 6 |
| | | Jazz | 5 | 1980s | 9 | | |
| | | New Wave | 2 | 1990s | 5 | | |
| | | Punk | 4 | 2000s | 5 | | |
| | | Dance | 2 | | | | |
| | | Country | 2 | | | | |

Thus, if a particular song to be scored is stored locally, is from the “Alternative Genre,” is from the “1980s” decade, and is a song by Elvis, the score of the song may be computed as:

$$Score = {\sum }_{i = 1}^{N} ( \frac{{W}_{CAT , i}}{20} \cdot \frac{{W}_{ATT , i}}{10} ) \cdot 100 = ( \frac{1}{20} \cdot \frac{5}{10} + \frac{7}{20} \cdot \frac{8}{10} + \frac{7}{20} \cdot \frac{9}{10} + \frac{5}{20} \cdot \frac{8}{10} ) \cdot 100 = 82.$$

Again, note that user preferences discussed above are exemplary scoring criteria. Any suitable criteria for scoring the media items in the playlist to reflect an expected desirability to the user may be used.

Once the media items are scored, the playlist is sorted based on the scores assigned to the media items (step 102). The playlist may be sorted using any desired sorting technique. In one embodiment, the playlist is sorted by score in descending order such that media items having the highest, or most desirable, scores are at the top of the playlist. However, the present invention is not limited thereto. For example, in another embodiment, the lowest score may be the most desirable score such that the playlist is sorted in ascending order. Note that while steps 100 and 102 are illustrated separately for clarity and ease of discussion, scoring and sorting of the media items in the playlist may be performed simultaneously. For example, the media items for the playlist may be identified. Each media item may then be individually processed to score the media item and place the media item in the playlist at the appropriate location or reposition the media item to the appropriate location.

Some time after sorting the playlist and preferably during playback of the playlist, a user event is detected with respect to one of the media items in the playlist (step 104). As discussed below, the user event may generally be a positive user event that results in increasing the scores of matching media items in the playlist or a negative user event that results in decreasing the scores of matching media items in the playlist. The user event may be, for example, skipping the media item to proceed to a next media item in the playlist (negative user event), repeating playback of the media item (positive user event), manually decreasing the score of the media item (negative user event), manually increasing the score of the media item (positive user event), applying a rating to the media item (positive or negative user event), explicitly recommending the media item to one or more other users (positive user event), or the like.

In addition to detecting the user event, a magnitude of the user event may be determined. The manner in which the magnitude of the user event is determined may vary depending on the type of user event. For example, if the user event is skipping the media item to proceed to a next media item in the playlist, the magnitude of the user event may be a function of an amount of the media item that was played before the user chose to skip to the next media item in the playlist. The magnitude may be greatest if the user skips the media item before playing any of the media item and least if the user skips to the next media item after playing a threshold amount or threshold percentage of the media item. Note that if the user skips to the next media item after playing the threshold amount or percentage of the media item, no user event may be detected or the magnitude of the user event may be set to zero or some other minimum value. As an example, if the media item is a song, the threshold may be a predefined amount such as one-minute and thirty-seconds (1:30). As another example, the threshold may be a predefined percentage such as 75%.

If the user event is repeating or replaying the media item, the magnitude may be a function of an amount of the media item played by the user before the user chose to repeat the media item. The magnitude may be greatest if the user repeats the media item after playing all or substantially all of the media item and least if the user repeats the media item after playing less than a threshold amount or threshold percentage of the media item. Note that if the user repeats the media item before playing at least the threshold amount or percentage of the media item, no user event may be detected or the magnitude of the user event may be set to zero or some other minimum value. As an example, if the media item is a song, the threshold may be a predefined amount such as ten (10) seconds. As another example, the threshold may be a predefined percentage such as 10%.

If the user event is manually rescoring the media item, the magnitude may be a function of a numerical value corresponding to the change in the score of the media item or a percentage of change in the score of the media item. If the user event is applying a rating to the media item, the magnitude may be a function of the rating. For example, if the rating may be one (1) to (5) stars, then the user event may be considered a positive user event if the user applies a rating of three (3) to five (5) stars and a negative user event if the user applies a rating of one (1) to two (2) stars. The magnitude may then be a function of the applied rating. For an applied rating in the range of three (3) to five (5) stars, the greater the rating, then the greater the magnitude of the user event. For an applied rating in the range of one (1) to two (2) stars, the lesser the rating, then the greater the magnitude of the user event. Similarly, the user event may be a change in the rating applied to the media item. An increase in the rating may be a positive event whereas a decrease in the rating may be a negative event. The magnitude may then be a function of the amount of change in the rating. Lastly, if the user event is explicitly recommending the media item to one or more other users, the magnitude may be a function of, for example, a number of recipients of the recommendation. The greater the number of recipients, the greater the magnitude.

Again, note that the types of user events mentioned above are exemplary and are not intended to limit the scope of the present invention. One of ordinary skill in the art will recognize numerous types of user events that may be detected and utilized in the process of FIG. 1 upon reading this disclosure. All such user events should be considered within the scope of the present invention.

In this embodiment, after detecting the user event, a reason for the user event is determined (step 106). Note that step 106 is optional and not necessary for all embodiments of the present invention. In one embodiment, a prompt including a list of potential reasons for the user event is presented to the user. The user is then enabled to select the reason for the user event from the list of potential reasons for the user event. For example, if the media item with respect to which the user event occurred is a song, the list of potential reasons for the user event included in the prompt may be the artist of the song, an album on which the song was released, a genre of the song, a decade of release of the song, a source of the song, a style (e.g., melody, harmony, instrumentation, rhythm, vocals, lyrics, or the like) of the song, or the like.

The list of potential reasons presented to the user may be a static list of potential reasons. Alternatively, the potential reasons may be based on the type of user event, the media item with respect to which the user event occurred, the scoring criteria used for the scoring algorithm, and reasons given for previous user events. For example, the list of potential reasons may include source for user events such as skipping a media item but not for other user events such as replaying the media item. As another example, the list of potential reasons may include tempo for media items such as songs but not for media items such as videos. As another example, the list of potential reasons may include one or more potential reasons corresponding to the scoring criteria used to score the media items in the playlist. Thus, if genre, artist, and decade are scoring criteria used to score the media items, then the potential list of reasons may include genre, artist, and decade. As a final example, the list of potential reasons may vary depending on reasons given by the user for one or more previous user events. Thus, if the user previously skipped a media item because of the artist, the next time the user skips that same media item the artist may not be included in the list of potential reasons for skipping the media item.

In addition, a default reason from the list of potential reasons may be automatically recommended to the user based on a historical record of reasons given by the user in the past. For example, if the user event is skipping a media item in the playlist and the user previously skipped the media item or a similar media item because of the genre in the same playback session or a previous playback session, the genre of the media item may be recommended to the user as the reason for skipping the media item. The genre may be recommended as the reason for the user event by, for example, highlighting “genre” in the list of potential reasons included in the prompt presented to the user. Still further, in one embodiment, if the user does not select a reason for the user event from the list of potential reasons included in the prompt within a predefined amount of time, the default reason may be automatically selected as the reason for the user event. In an alternative embodiment, the user may not be prompted, and the default reason may be automatically selected as the reason for the user event.

Once the reason for the user event is determined, matching media items in the playlist are identified and rescored (step 108). Generally, in one embodiment, each media item in the playlist is processed to determine whether, and optionally to what degree, the media item matches the media item with respect to which the user event occurred in light of the reason for the user event. Then, in this embodiment, the media item is rescored as a function of: (1) a degree to which the media item matches the media item with respect to which the user event occurred in light of the reason for the user event and (2) a magnitude of the user event. In an alternative embodiment, the magnitude of the user event may not be determined. As such, the media item may be rescored as a function of a degree to which the media item matches the media item with respect to which the user event occurred in light of the reason for the user event.

More specifically, in one embodiment, for each media item in the playlist, a matching factor (MF) is determined. The matching factor (MF) reflects a degree to which the media item matches the media item with respect to which the user event occurred (e.g., media item skipped, media item replayed, media item rescored, media item ranked, media item recommended, or the like) in light of the reason for the user event. For example, if the user event occurred with respect to the song “Rock-a-Hula Baby” by Elvis Presley from the Rock genre and the reason for the user event is the genre of the song, then the matching factor (MF) reflects a degree to which the genre of the media item being processed matches the Rock genre. For example, genres and sub-genres of music may be represented by an ontology or similar classification data structure. The matching factor (MF) may therefore be a function of the number of degrees of separation between the Rock genre and the genre of the media item being processed. As an example, zero degrees of separation may correspond to a matching factor (MF) of 10/10, one degree of separation may correspond to a matching factor (MF) of 7/10, two degrees of separation may correspond to a matching factor (MF) of 4/10, three degrees of separation may correspond to a matching factor (MF) of 1/10, and greater than three degrees of separation may correspond to a matching factor (MF) of 0/10. If the media item has a matching factor (MF) of 0/10, then it may be determined that the media item is not a matching media item and is therefore not rescored.

As another example, if the user event occurred with respect to the song “Rock-a-Hula Baby” by Elvis Presley and the reason for the user event is the style of the song, then the matching factor (MF) reflects a degree to which the style of the media item being processed matches the style of “Rock-a-Hula Baby” by Elvis Presley. As used herein, the style of a media item is defined one or attributes of the media content itself. For example, the style of a song may include one or more attributes such as melody, harmony, instrumentation, rhythm, vocals, lyrics, or the like. The matching factor (MF) for the media item being issued may be a function of the number of attributes of the media item being processed that match the attributes of “Rock-a-Hula Baby” by Elvis Presley.

Once the matching factor (MF) is determined, a user event score (UES) is determined based on the equations:

UES=MF·Mag for positive user events and

UES=−MF·Mag for negative user events,

where UES is the user event score, MF is the matching factor, and Mag is the magnitude of the user event. In this example, the matching factor (MF) and the magnitude (Mag) of the user event are values in the range of one (1) to ten (10). In addition, in one embodiment, previous user event scores (UESs) for the same playback session may also be recorded and taken into account. As such, if one or more previous user events have been detected and previously processed during the playback session, the user event score (UES) is combined with previous user event scores (UESs) for the previously detected user events to provide an overall user event score (OUES). The overall user event score (OUES) may be, for example, an average of all user event scores including the current UES and the previous UESs and defined by the equation:

$$OUES = \frac{{\sum }_{i}^{M} {UES}_{i}}{M} ,$$

where M is the number of UESs including the current UES and previous UESs.

At this point, for the media item being processed, the OUES is a value in the range of −100 to 100. The OUES may then be used to rescore the media being processed. In one embodiment, the media item being processed is rescored based on the following equations:

$$If OUES > 0 \text{:}$$

$$NewScore = BaselineScore + ( \frac{OUES}{100} \cdot SIF \cdot ( 100 - BaselineScore ) ) , \\ and$$

$$If OUES < 0 \text{:}$$

$$NewScore = BaselineScore - ( \frac{OUES}{100} \cdot SIF \cdot BaselineScore ) ,$$

where “BaselineScore” is the initial score of the media item provided in step 100 and SIF is a session influence factor having a value of zero (0) to one (1). The session influence factor (SIF) is a user-controlled setting that may be used by the user to control the amount of influence that user events are to be given in rescoring the media items in the playlist. If the SIF is set to zero (0), then the user events have no influence on the score of the media items in the playlist. If the SIF is set to one (1), then the user events have a maximum amount of influence on the scores of the media items in the playlist.

The process continues to rescore all matching media items in the playlist. The process then returns to step 102 where the playlist is resorted based on the updated scores of the media items in the playlist, and the process is repeated to continually rescore the media items in the playlist in response to detected user events. Note that while scoring the media items and resorting the playlist are illustrated as separate steps for clarity and ease of discussion, scoring the media items and resorting the playlist may be implemented as a single process or separate processes. For example, all of the matching media items may be rescored and, subsequently, the playlist may be resorted. As another example, as the media items are rescored, the media items may be repositioned in the playlist according to their new scores. Thus, in other words, the rescoring of the matching media items and the resorting of the playlist may occur simultaneously.

Also, in one embodiment, the rescoring of the media items in the playlist according to the process of FIG. 1 may be temporary or session-based. More specifically, during a playback session when the user is experiencing the playlist and interacting with the playlist, user events may be detected, and the media items in the playlist may be rescored based on the user events in the manner discussed above. The new scores for the media items may be temporary and last only during the current playback session. When the user ends the session and subsequently initiates a new playback session, the scores of the media items in the playlist may revert to the initial or baseline scores determined in step 100. Even if the rescoring is temporary, the user may choose persist the changes in the scores of the media items by instructing the playlist control function to revise the user preferences of the user accordingly.

As another example, the user preferences used to score the media items may include user preferences for multiple “channels” such as, for example, “80s Rock,” “Workout,” “Party Mix,” or the like. Each of the channels may include, for example, independently controlled user preferences. For example, in the embodiment where the user preferences include weights assigned to each of a number of scoring categories and weights assigned to each of a number of attributes in each of the scoring categories, each of the channels may have independently controlled scoring category and attribute weights. Thus, the user may choose to persist the changes made to the scores of the media items in the playlist in response to user events as corresponding user preferences for a new media channel. In yet another embodiment, the rescoring of the media items may be permanent. The rescoring may be made permanent by, for example, permanently adjusting the applicable user preferences utilized to score the media items in the playlist.

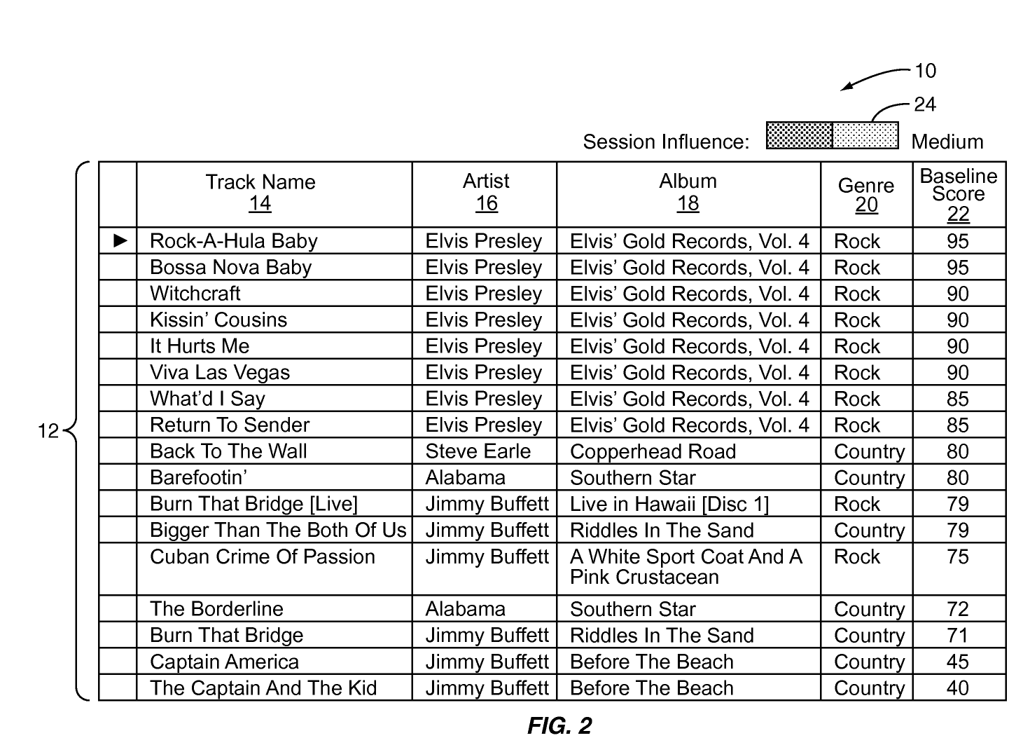

FIGS. 2 through 4 illustrate a Graphical User Interface (GUI) 10 presented by a playlist control function that rescores media items in a playlist utilizing the process of FIG. 1 according to one embodiment of the present invention. FIG. 2 illustrates the GUI 10 in an initial state where a number of media items, which in this example are songs, in a playlist 12 are scored, and the playlist 12 is sorted based on the scores of the songs. In this example, the playlist 12 includes a track name, or song name, column 14 providing names of the songs in the playlist 12; an artist column 16 providing the artist names for the songs in the playlist 12; an album column 18 providing the album names for the songs in the playlist 12; a genre column 20 providing the genres for the songs in the playlist 12; and a score column 22 providing the scores of the songs in the playlist 12. Initially, the scores of the songs in the playlist are the initial scores, or baseline scores, determined in step 100 of the process of FIG. 1. Lastly, the GUI 10 includes a session influence control 24 which enables the user to adjust an influence of user events on the scores of the songs in the playlist 12 for the current playback session. Note that the information contained in the GUI 10 is exemplary and not intended to limit the scope of the present information. More or less information may be included in the GUI 10.

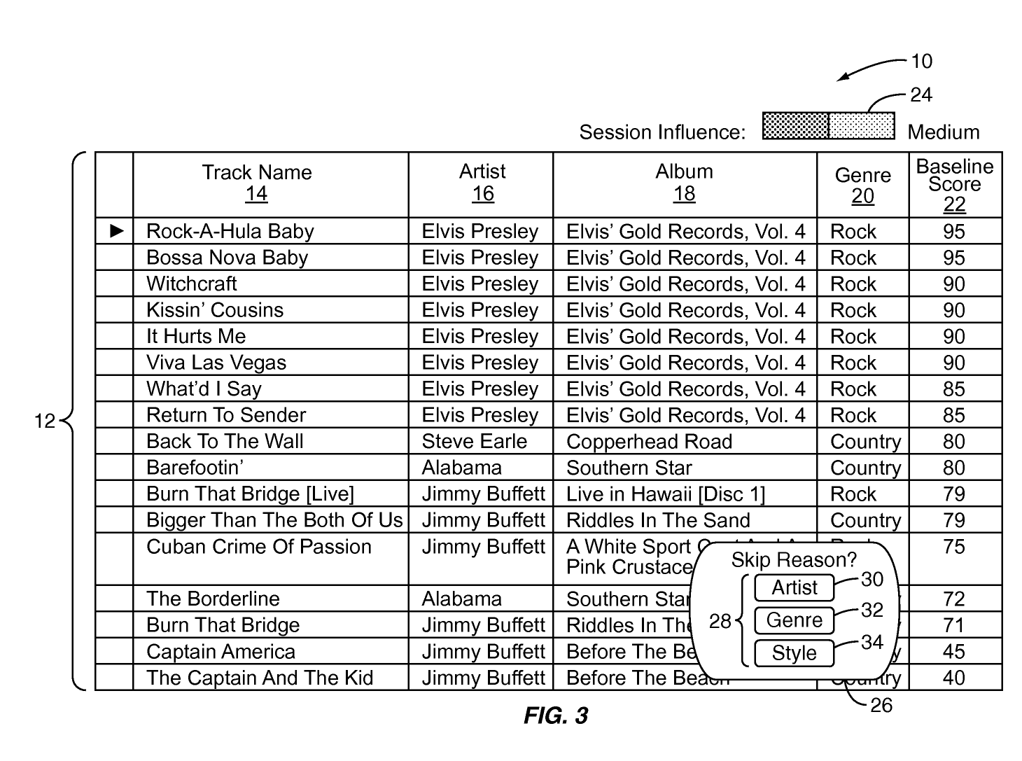

In this example, the user is initially listening to “Rock-a-Hula Baby” by Elvis Presley. At some point during playback, the user chooses to skip to the next song in the playlist 12. In response, as illustrated in FIG. 3, a prompt 26 is presented to the user. The prompt 26 includes a list of potential reasons 28 for the user event, which in this example is the skipping of the song “Rock-a-Hula Baby” by Elvis Presley. In this example, the list of potential reasons 28 includes artist, genre, and style, which are represented by corresponding buttons 30, 32, and 34, respectively. By clicking on the button 30, the user can select the artist, which in this example is Elvis Presley, as the reason for the user event. By clicking on the button 32, the user can select the genre, which in this example is Rock, as the reason for the user event. Lastly, by clicking on the button 34, the user can select the style of the song “Rock-a-Hula Baby” by Elvis Presley as the reason for the user event. In this example, the user selects the button 30, thereby selecting the artist as the reason for the user event.

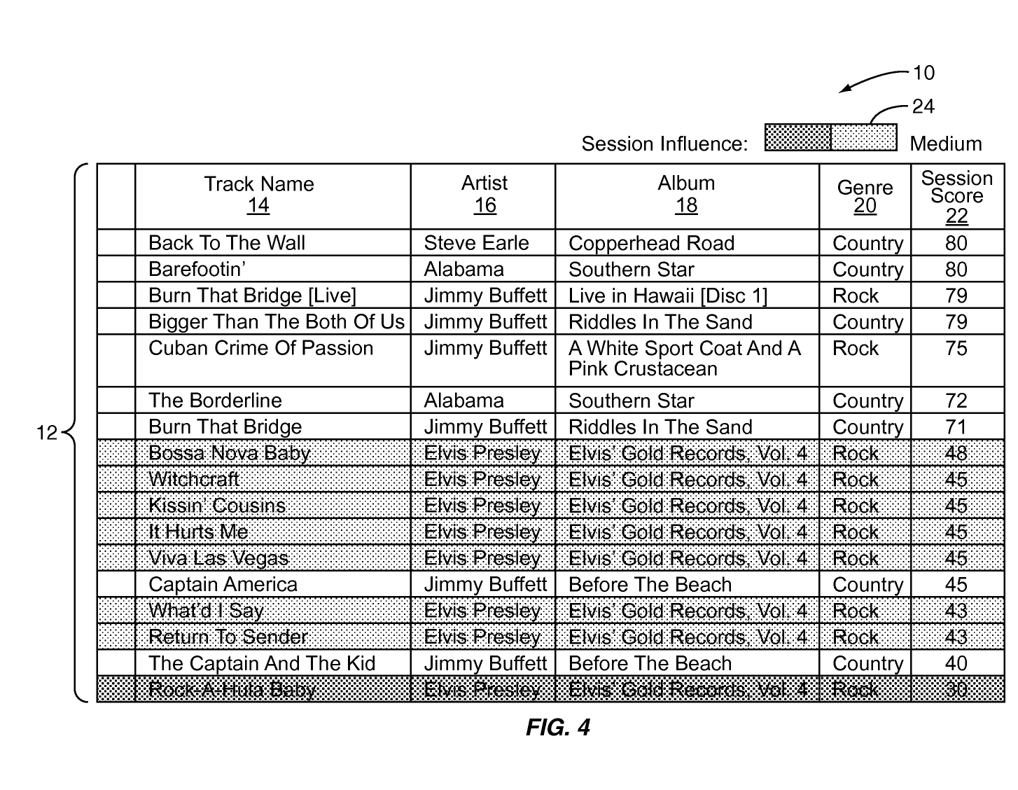

In response to the user event and the reason for the user event, the songs in the playlist 12 are rescored and the playlist 12 is resorted, as described above. The resulting playlist 12 is illustrated in FIG. 4. As shown, the songs by Elvis Presley have been rescored in response to the user event. Since skipping a media item is a negative user event, the new scores of the songs by Elvis Presley have been reduced as compared to their previous scores. Also note that the scores 22 are now the session scores for the songs in the playlist 12. Note that, in one embodiment, if the user were to terminate playback of the playlist and subsequently initiate a new playback session, the scores of the songs in the playlist 12 revert to the initial or baseline scores shown in FIG. 2. However, in another embodiment, the new scores for the songs in the playlist 12 may be persisted either by adjusting the user preferences used to score the songs in the playlist 12 or by creating a new channel profile, as discussed above.

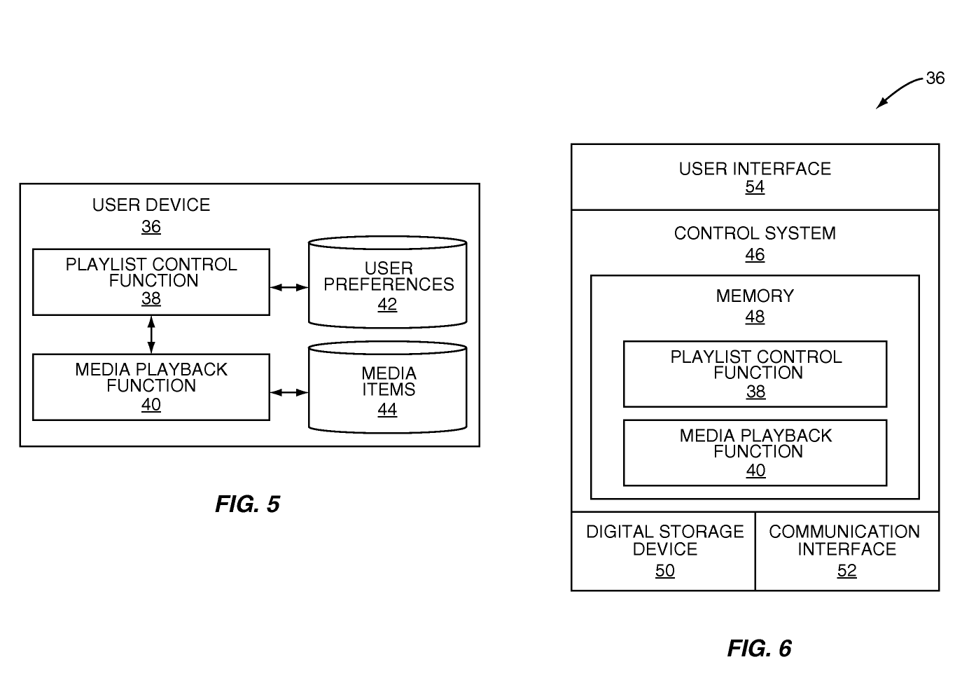

FIG. 5 is a functional block diagram of a user device 36 including a playlist control function 38 for rescoring media items in a playlist in response to user events according to one embodiment of the present invention. In general, the user device 36 may be, for example, a personal computer, a portable media player, a mobile smart phone having media playback capabilities, or the like. The user device 36 includes the playlist control function 38 and a media playback function 40, each of which may be implemented in software, hardware, or a combination thereof. In one exemplary embodiment, the media playback function 40 is implemented as a software application, and the playlist control function 38 is a plug-in to that software application. In another exemplary embodiment, the playlist control function 38 and the media playback function 40 are implemented within a single software application. In addition, the user device 36 stores user preferences 42 and a number of media items 44, which may be songs, videos, or the like. As discussed above, in one embodiment, the user preferences 42 include weights assigned to a number of scoring categories and weights assigned to attributes within each of the scoring categories. However, the present invention is not limited thereto.

The playlist control function 38 generally operates to score media items in a playlist based on the user preferences 42 of the user of the user device 36 and sort the playlist based on the scores of the media items in the playlist. In one embodiment, the playlist control function 38 may then execute the playlist to control playback of the media items via the media playback function 40 according to the playlist. Alternatively, the playlist control function 38 may provide the playlist to the media playback function 40 for execution. Thereafter, the playlist control function 38 detects user events (e.g., input from the user skipping a media item in the playlist, input from the user replaying a media item in the playlist, input from the user manually rescoring a media item in the playlist, input from the user initiating an explicit recommendation of a media item in the playlist to one or more other users, input from the user applying a rating to a media item in the playlist, or the like). In response to the user events, the playlist control function 38 rescores the media items in the playlist and resorts the playlist in the manner described above.

FIG. 6 is a block diagram illustrating an exemplary hardware implementation of the user device 36 of FIG. 5. In this embodiment, the user device 36 includes a control system 46 having associated memory 48. In this example, the playlist control function 38 and the media playback function 40 are implemented in software and stored in the memory 48. However, the present invention is not limited thereto. Each of the playlist control function 38 and the media playback function 40 may be implemented in software, hardware, or a combination thereof. In addition, the user device 36 may include a digital storage device 50 such as a hard disk drive or the like. The user preferences 42 and the media items 44 may be stored in the digital storage device 50, the memory 48, or a combination thereof. Still further, the user device 36 may include a communication interface 52 such as, for example, a mobile telecommunications network interface, a local wireless network interface (e.g., Bluetooth interface, IEEE 802.11x interface, or the like), a local wired connection interface (e.g., Firewire interface, USB interface, or the like), or the like. Lastly, the user device 36 includes a user interface 54, which includes components such as a display, one or more user input devices, one or more speakers, or the like.

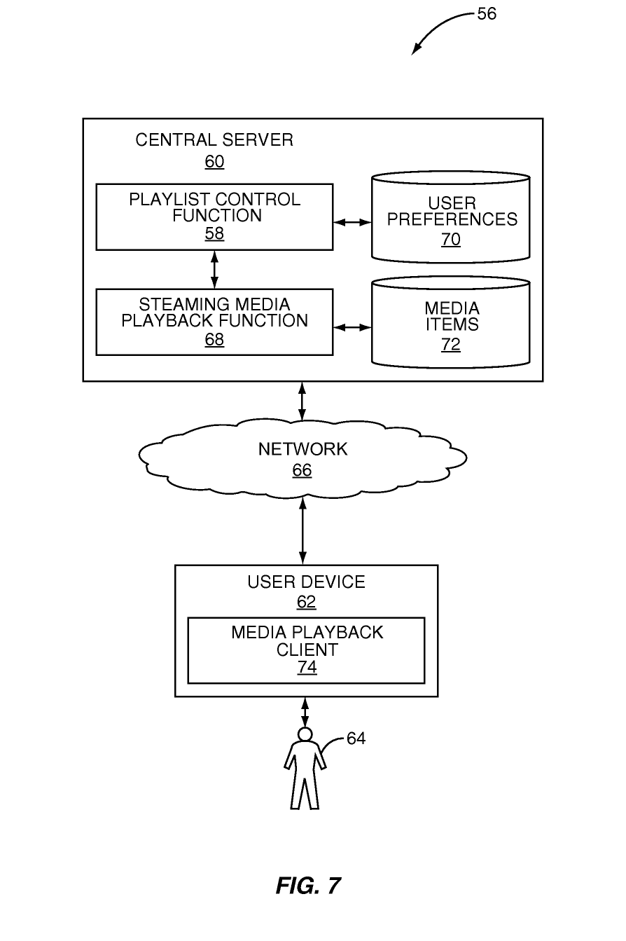

FIG. 7 illustrates a system 56 implementing a playlist control function 58 for rescoring media items in a playlist in response to user events according to another embodiment of the present invention. In general, the system 56 includes a central server 60 and a user device 62 having an associated user 64. Note that while only one user device 62 is illustrated, the central server 60 may serve any number of one or more user devices 62. The central server 60 and the user device 62 are connected by a network 66. The network 66 may be any type of Wide Area Network (WAN) or Local Area Network (LAN), or any combination thereof. In addition, the network 66 may include wired components, wireless components, or a combination thereof. For example, the network 66 may be the Internet.

The central server 60 includes the playlist control function 58 and a streaming media playback function 68, each of which may be implemented in software, hardware, or a combination thereof. Note that while the playback control function 58 and the streaming media playback function 68 are illustrated separately for clarity and ease of discussion, the playlist control function 58 and the streaming media playback function 68 may be implemented separately or as a single hardware and/or software application. The central server 60 also hosts or otherwise has access to user preferences 70 including user preferences of the user 64 and a number of media items 72, which may be songs, videos, or the like. As discussed above, in one embodiment, the user preferences 70 of the user 64 include weights assigned to a number of scoring categories and weights assigned to attributes within each of the scoring categories. However, the present invention is not limited thereto.

The playlist control function 58 generally operates to score media items in a playlist generated by or on behalf of the user 64 based on the user preferences 70 of the user 64 and sort the playlist based on the scores of the media items in the playlist. In one embodiment, the playlist control function 58 may then execute the playlist to control playback of the media items via the streaming media playback function 68 according to the playlist. Alternatively, the playlist control function 58 may provide the playlist to the streaming media playback function 68 for execution. In either case, the streaming media playback function 68 then streams the media items in the playlist to the user device 62 of the user 64 for presentation to the user 64. Thereafter, the playlist control function 58 detects user events (e.g., input from the user 64 skipping a media item in the playlist, input from the user 64 replaying a media item in the playlist, input from the user 64 manually rescoring a media item in the playlist, input from the user 64 initiating an explicit recommendation of a media item in the playlist to one or more other users, input from the user applying a rating to a media item in the playlist, or the like). In response to the user events, the playlist control function 58 rescores the media items in the playlist and resorts the playlist in the manner described above.

The user device 62 may be, for example, a personal computer, a portable media player having network capabilities, a mobile smart phone having media playback capabilities, or the like. The user device 62 includes a media playback client 74, which may be implemented in software, hardware, or a combination thereof. In this embodiment, the media playback client 74 provides playback of the streaming media items received from the central server 60. In addition, the media playback client 74 enables the user 64 to control playback of the media items (e.g., skip a media item in the playlist being streamed, replay a media item in the playlist being streamed, or the like). The media playback client 74 may also enable the user 64 to cause other user events such as, for example, manually rescoring a media item in the playlist, initiating an explicit recommendation of a media item in the playlist to one or more other users, applying a rating to a media item in the playlist being streamed, or the like.

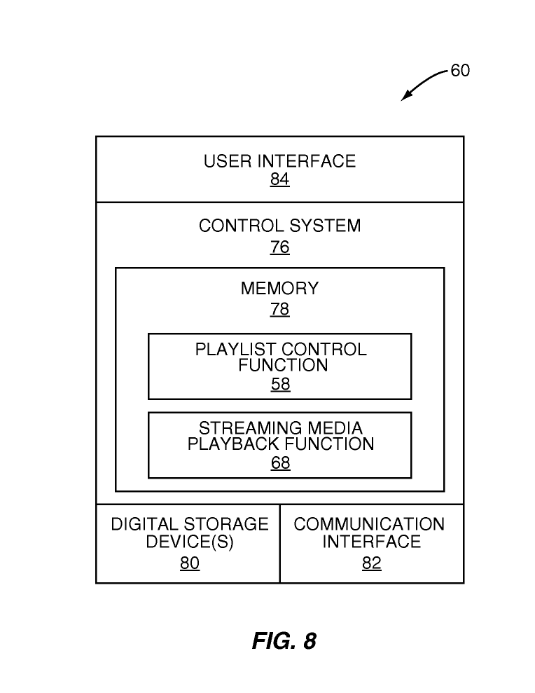

FIG. 8 is a block diagram of the central server 60 of FIG. 7 according to one embodiment of the present invention. In general, the central server 60 includes a control system 76 having associated memory 78. In this example, the playlist control function 58 and the streaming media playback function 68 are implemented in software and stored in the memory 78. However, the present invention is not limited thereto. Each of the playlist control function 58 and the streaming media playback function 68 may be implemented in software, hardware, or a combination thereof. The central server 60 may also include one or more digital storage devices 80 such as one or more hard disk drives or the like. The user preferences 70 (FIG. 7) and the media items 72 (FIG. 7) may be stored in the one or more digital storage devices 80, the memory 78, or a combination thereof. In addition, the central server 60 includes a communication interface 82 communicatively coupling the central server 60 to the network 66 (FIG. 7). Lastly, the central server 60 may include a user interface 84, which may include components such as, for example, a display, one or more user input devices, or the like.

Those skilled in the art will recognize improvements and modifications to the preferred embodiments of the present invention. All such improvements and modifications are considered within the scope of the concepts disclosed herein and the claims that follow.

What is claimed is:

1. A method comprising:
scoring a plurality of media items;
providing a playlist comprising the plurality of media items and sorted based on scores of the plurality of media items;
detecting a user event with respect to one of the plurality of media items in the playlist;
determining a reason for the user event;
adjusting a score of at least one matching media item from the plurality of media items in the playlist in response to detecting the user event, the at least one matching media item matching, at least to some degree, the one of the plurality of media items with respect to which the user event was detected in light of the reason for the user event; and
updating the playlist in response to rescoring the at least one matching media item such that the playlist is sorted based on the scores of the plurality of media items.

2. The method of claim 1 wherein scoring the plurality of media items comprises scoring each of the plurality of media items based on user preferences of an associated user.

3. The method of claim 1 wherein the user event is one of a group consisting of: skipping the one of the plurality of media items in the playlist, replaying the one of the plurality of media items in the playlist, manually rescoring the one of the plurality of media items in the playlist, rating the one of the plurality of media items in the playlist, and recommending the one of the plurality of media items to one or more other users.

4. The method of claim 1 wherein determining the reason for the user event comprises:
presenting a list of potential reasons for the user event to an associated user; and
receiving user input from the associated user identifying a potential reason from the list of potential reasons as the reason for the user event.

5. The method of claim 4 wherein the list of potential reasons comprises a plurality of potential reasons selected based on at least one of a group consisting of: a user event type of the user event, the one of the plurality of media items with respect to which the user event occurred, historical information regarding a reason given by the associated user to a previous user event, and user preferences used to score the plurality of media items.

6. The method of claim 1 wherein determining the reason for the user event comprises:
identifying one of a plurality of potential reasons for the user event as a recommended reason for the user event based on historical information related to reasons given by an associated user for previous user events;
presenting a list of potential reasons for the user event to the associated user, the list of potential reasons including the plurality of potential reasons for the user event and identifying the recommended reason for the user event; and
receiving user input from the associated user identifying a potential reason from the list of potential reasons as the reason for the user event.

7. The method of claim 1 wherein determining the reason for the user event comprises:
identifying one of a plurality of potential reasons for the user event as a recommended reason for the user event based on historical information related to reasons given by an associated user for previous user events;
presenting a list of potential reasons for the user event to the associated user, the list of potential reasons including the plurality of potential reasons for the user event and identifying the recommended reason for the user event; and
automatically selecting the recommended reason as the reason for the user event if user input identifying a potential reason from the list of potential reasons as the reason for the user event is not received from the associated user within a predefined amount of time.

8. The method of claim 1 wherein determining the reason for the user event comprises:
identifying one of a plurality of potential reasons for the user event as a default reason for the user event based on historical information related to reasons given by an associated user for previous user events; and
automatically selecting the default reason as the reason for the user event.

9. The method of claim 1 wherein the at least one matching media item comprises at least one media item of the plurality of media items other than the one of the plurality of media items with respect to which the user event was detected.

10. The method of claim 1 wherein adjusting the score of the at least one matching media item comprises adjusting the score of the at least one matching media item as a function of a degree to which the at least one matching media item matches the one of the plurality of media items with respect to which the user event was detected in light of the reason for the user event.

11. The method of claim 1 wherein adjusting the score of the at least one matching media item comprises adjusting the score of the at least one matching media item as a function of: (a) a degree to which the at least one matching media item matches the one of the plurality of media items with respect to which the user event was detected in light of the reason for the user event and (b) a magnitude of the user event.

12. The method of claim 1 wherein adjusting the score of the at least one matching media item comprises, for each media item of the plurality of media items in the playlist:
determining a degree to which the media item matches the one of the plurality of media items with respect to which the user event was detected in light of the reason for the user event; and
adjusting the score of the media item as a function of the degree to which the media item matches the one of the plurality of media items with respect to which the user event was detected in light of the reason for the user event.

13. The method of claim 12 further comprising:
determining a magnitude of the user event;
wherein adjusting the score of the media item as a function of the degree to which the media item matches the one of the plurality of media items comprises adjusting the score of the media item as a function of: (a) the degree to which the media item matches the one of the plurality of media items with respect to which the user event was detected in light of the reason for the user event and (b) the magnitude of the user event.

14. The method of claim 1 wherein the user event is identified as a positive user event, and adjusting the score of the at least one matching media item comprises increasing the score of the at least one media item.

15. The method of claim 1 wherein the user event is identified as a negative user event, and adjusting the score of the at least one matching media item comprises decreasing the score of the at least one media item.

16. The method of claim 1 wherein adjusting the score of the at least one matching media item comprises generating a temporary score for the at least one matching media item.

17. The method of claim 1 wherein adjusting the score of the at least one matching media item comprises generating a session score for the at least one matching media item to be used only for a current playback session.

18. The method of claim 17 further comprising enabling an associated user to persist the session score for the at least one matching media item.

19. The method of claim 18 wherein the session score for the at least one matching media item is persisted by updating user preferences utilized to score the plurality of media items.

20. The method of claim 1 wherein adjusting the score of the at least one matching media item comprises permanently adjusting the score of the at least one matching media item.

21. A user device comprising:
a media playback function adapted to provide playback of a plurality of media items in a playlist; and
a playlist control function associated with the media playback function and adapted to:
score the plurality of media items, wherein the playlist is sorted based on scores of the plurality of media items;
detect a user event with respect to one of the plurality of media items in the playlist;
determine a reason for the user event;
adjust a score of at least one matching media item from the plurality of media items in the playlist in response to detecting the user event, the at least one matching media item matching, at least to some degree, the one of the plurality of media items with respect to which the user event was detected in light of the reason for the user event; and
update the playlist in response to rescoring the at least one matching media item such that the playlist is sorted based on the scores of the plurality of media items.

22. A central server comprising:
a communication interface communicatively coupling the central server to a user device of a user via a network; and
a control system associated with the communication interface and adapted to:
score a plurality of media items;
provide a playlist comprising the plurality of media items and sorted based on scores of the plurality of media items;
stream the plurality of media items to the user device of the user according to the playlist;
detect a user event caused by the user with respect to one of the plurality of media items in the playlist;
determine a reason for the user event;
adjust a score of at least one matching media item from the plurality of media items in the playlist in response to detecting the user event, the at least one matching media item matching, at least to some degree, the one of the plurality of media items with respect to which the user event was detected in light of the reason for the user event; and
update the playlist in response to rescoring the at least one matching media item such that the playlist is sorted based on the scores of the plurality of media items.

23. A computer readable medium comprising software for instructing a computing device to:
score a plurality of media items;
provide a playlist comprising the plurality of media items and sorted based on scores of the plurality of media items;
detect a user event with respect to one of the plurality of media items in the playlist;
determine a reason for the user event;
adjust a score of at least one matching media item from the plurality of media items in the playlist in response to detecting the user event, the at least one matching media item matching, at least to some degree, the one of the plurality of media items with respect to which the user event was detected in light of the reason for the user event; and
update the playlist in response to rescoring the at least one matching media item such that the playlist is sorted based on the scores of the plurality of media items.

24. A method comprising:
scoring a plurality of media items;
providing a playlist comprising the plurality of media items and sorted based on scores of the plurality of media items;
providing playback of the plurality of media items according to the playlist for a current playback session;
detecting a user event with respect to one of the plurality of media items in the playlist;
adjusting a score of at least one matching media item from the plurality of media items in the playlist in response to detecting the user event to provide a session score for the at least one matching media item that is used only for the current playback session, the at least one matching media item matching, at least to some degree, the one of the plurality of media items with respect to which the user event was detected; and
updating the playlist in response to rescoring the at least one matching media item such that the playlist is sorted based on the scores of the plurality of media items.

25. The method of claim 24 further comprising enabling an associated user to persist the session score for the at least one matching media item.

26. The method of claim 25 wherein the session score for the at least one matching media item is persisted by updating user preferences utilized to score the plurality of media items.
